(19) United States
(12) Patent Application Publication
(10) Pub. No.: US 2024/0302500 A1
(43) Pub. Date: Sep. 12, 2024

(54) LIGHT-EMITTING MODULE, CAMERA MODULE AND ELECTRONIC DEVICE

(71) Applicant: TRIPLE WIN TECHNOLOGY (SHENZHEN) CO. LTD., Shenzhen (CN)

(72) Inventor: JUI-WEN CHANG, Shenzhen (CN)

(21) Appl. No.: 18/382,651

(22) Filed: Oct. 23, 2023

(30) Foreign Application Priority Data
Mar. 10, 2023 (CN) 202310237917.2

(51) Int. Cl. G01S 7/481; G01S 17/894

(52) U.S. Cl. CPC G01S 7/4815; G01S 17/894

(57) ABSTRACT

A light-emitting module includes a light source module, a collimating lens module and a deflecting diffraction module. The light source module includes at least two light source arrays. Each light source arrays is configured to emit beams of detection light. The collimating lens module is on an output side of the light source module and includes a plurality of collimating lenses. The deflecting diffraction module is on a side of the collimating lens module facing away the light source module. The deflecting diffraction module is configured to superimpose groups of the detection light.

### FIELD

The subject matter herein generally relates to a light-emitting module, a camera module having the light-emitting module and an electronic device having the camera module.

### BACKGROUND

With the rapid development of three-dimensional (3D) cameras, time of flight (ToF) imaging is applied into intelligent products more and more, further enriching the application scenarios of 3D visual sensing technology. For example, ToF imaging can be applied to scenes including 3D face recognition, 3D modeling, gesture recognition, body games, augmented reality, and virtual reality, bringing a fun and practical experience to intelligent products. ToF technology, which is favored by mobile terminals due to its own advantages, has made up for the limitation of imaging effects in a small range and continues to develop in the 3D visual sensing technology. The 3D cameras are superior to the two-dimensional (2D) cameras in terms of anti-interference and night vision, and can also collect real-time 3D position information, image information, and size information of the target object. Direct ToF (dToF) imaging is currently one of the two mainstream ToF technologies. The principle of dToF is to directly emit detection light pulse signals to the target object and measure the time interval between reflected and emitted detection light to obtain the flight time of the light, thereby directly calculating the distance that the detection light.

However, the 3D cameras on the market can only obtain 3D image effects within a certain distance range, beyond which 3D image effects cannot be presented due to sparse density of detection light spots on object, resulting in unclear images. On one hand, when 3D cameras perform dToF imaging, the distribution density of detection light points emitted by the light emission array on the target object is sparse, resulting in poor resolution. On the other hand, due to factors such as the heating and power supply circuit design of the current optical emission array, the distribution density of the emission unit array cannot be increased, thus unable to increase the distribution density of detection light points on the target object.

Therefore, there is room for improvement in the art.

### BRIEF DESCRIPTION OF THE DRAWINGS

Implementations of the present technology will now be described, by way of embodiments only, with reference to the attached figures.

FIG. 1 is a schematic view of a light-emitting module according to a first embodiment of the present disclosure.

FIG. 2 shows an array of detection light spots emitted by the light-emitting module onto a target object.

FIG. 3 is a schematic view of a light source module in FIG. 1.

FIG. 4 is a schematic view of a light-emitting module according to a second embodiment of the present disclosure.

FIG. 5 is a schematic view of a light-emitting module according to a third embodiment of the present disclosure.

FIG. 6 is a schematic view showing a working principle of a camera module according to an embodiment of the present disclosure.

FIG. 7 is a schematic view of an electronic device according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

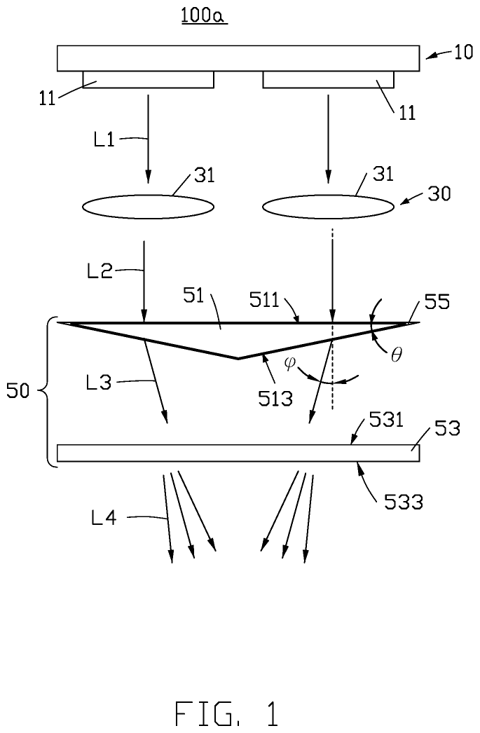

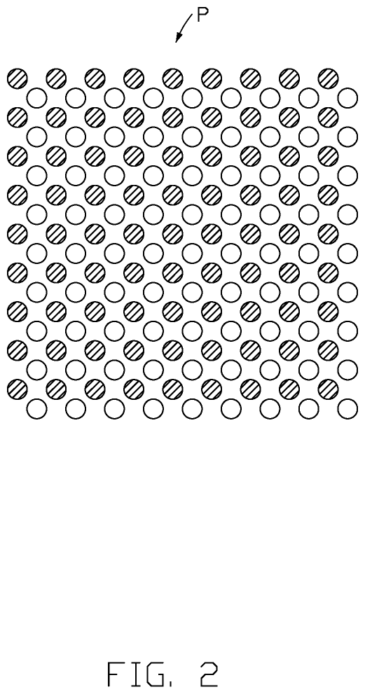

The present disclosure provides a light-emitting module. As shown in FIG. 1, the light-emitting module 100a includes a light source module 10, a collimating lens module 30, and a deflecting diffraction module 50. The light source module 10 is used to emit detection light L1. The collimating lens module 30 is on an output side of the light source module 10 and configured for collimating the detection light L1. The deflecting diffraction module 50 is located on a side of the collimating lens module 30 facing away the light source module 10. The deflecting diffraction module 50 is used to deflect different groups of the collimated detection light L2, and superimpose to form an array of detection light spots P as shown in FIG. 2.

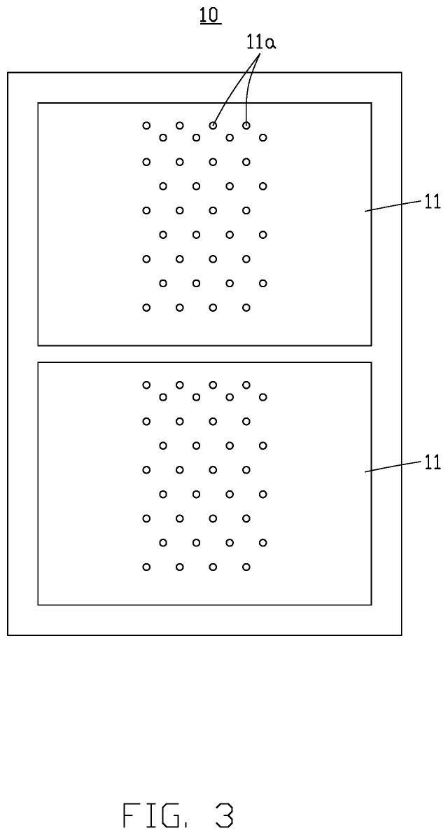

In this embodiment, the light source module 10 includes at least two light source arrays 11. FIG. 1 only shows two light source arrays 11. Each light source array 11 includes a plurality of lasers 11a as shown in FIG. 3. The lasers 11a in each light source array 11 can emit infrared light having the same wavelength as the detection light L1. Each light source arrays 11 emits a group of detection light L1, and the light source module 10 can emit several groups of detection light L1, while the wavelength of detection light L1 emitted by different light source arrays 11 is the same or different. Specifically, if the target object cannot reflect enough infrared light, some or all of the detection light L1 emitted by the light source module 10 can be near-infrared light having wavelength close to wavelength of red light, and even some of the detection light L1 can be red light. For example, as shown in FIG. 3, each light source array 11 of the light source module 10 can include a plurality of vertical cavity surface emitting lasers (VCSEL) 11a distributed two-dimensional, and the detection light L1 emitted by each VCSEL array can emit infrared light having a wavelength of 1550 nm or 940 nm, or some VCSEL arrays can emit red light having a wavelength of 660 nm. All of the lasers 11a of each light source array 11 does not emit light simultaneously, but the lasers 11a of each light source array 11 are divided into at least two batches, and the at least two batches alternately emit light.

In this embodiment, the collimating lens module 30 is used to collimate each group of detection light L1. The collimated detection light is called detection light L2. The collimating lens module 30 includes a plurality of collimating lenses 31. FIG. 1 only shows two collimating lenses 31. Each collimating lens 31 corresponds to one light source array 11 and collimate light from the one light source array 11.

In this embodiment, the deflecting diffraction module 50 includes a deflecting element 51, a diffraction element 53, and an anti-reflective film 55. The deflecting element 51 is used to deflect detection light L2 in different directions towards the object. The collimated detection light L2 enters the input surface 511 of the deflecting element 51, and then shoots out from the output surface 513 of the deflecting element 51. The detection light L2 deflects after passing through the deflecting element 51. Then the deflected detection light L3 be diffracted and divided through the input surface 531 and output surface 533 of the diffraction element 53. The angle between the propagation direction of the deflected detection light L3 and the propagation direction of the detection light L2 incident on the input surface 511 of the deflecting element 51 is a deviation angle φ. The deviation angle φ is influenced by the refractive index of the deflecting element 51 and an angle θ between the input surface 511 and the output surface 513 of the deflecting element 51. For example, if the refractive index of the deflecting element 51 is 1.5, and 0 is 3°, then e is about 1.5°. The deflecting element 51 is a transmission optical element that allows the detection light L2 to refract and pass through. In some embodiments, the diffraction element 53 can be removed and the deflecting diffraction module 50 does not include any diffraction element.

In the embodiment shown in FIG. 1, the deflecting element 51 is a deflecting prism corresponding to the entire light source module 10. The size of the deflecting element 51 is sufficient to receive all of the detection light L2 and deflect the detection light L2 in different directions and towards the same position. The diffraction element 53 is used to deflect the detection light L3. As shown in FIG. 1, the diffraction element 53 can be one corresponding to the entire light source module 10. The detection light L3 diffracts after passing through each diffraction unit, and overlaps at a certain distance (less than 5 meters; depends on wedge design), forming a specific light intensity distribution.

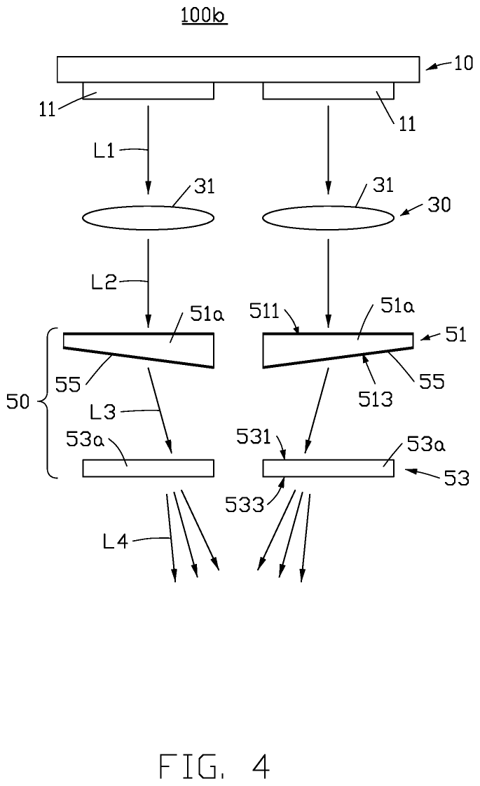

As shown in FIG. 4, in other embodiments, the deflecting element 51 in the light-emitting module 100b includes a plurality of wedges 51a, and each wedge 51a corresponds to one light source array 11. The diffraction element 53 includes a plurality of diffraction plates 53a, and each diffraction plate 53a corresponds to one light source array 11. Specifically, each light source array 11 emits a group of detection light L1, the detection light L1 is collimated into detection light L2 after passing through the collimating lens 31. The detection light L2 deflects into detection light L3 after passing through one wedge 51a, and then diffracted and divided into detection light L4 after passing through one diffraction plate 53a. Finally, a plurality of sets of detection light L4 having different deflection directions from different light source arrays 11 are superimposed to form an array of detection light spots P as shown in FIG. 2.

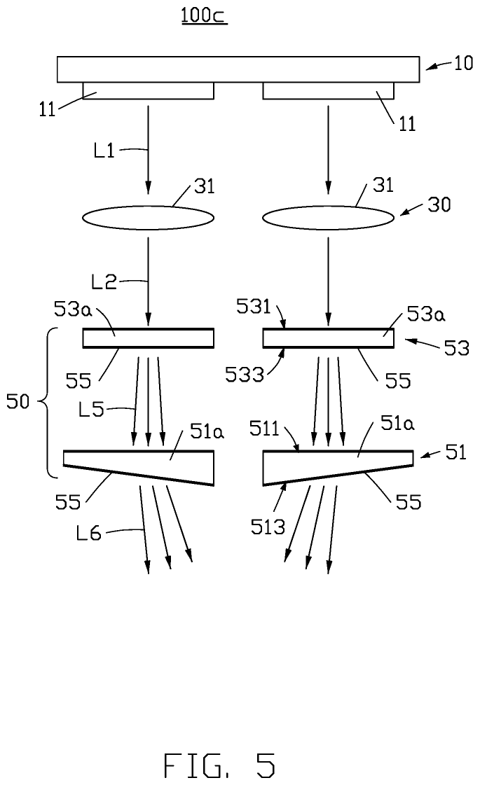

As shown in FIG. 1, the deflecting element 51 is located between the collimating lens module 30 and the diffraction element 53. In other embodiments, as shown in FIG. 5, in the light-emitting module 100c, the diffraction element 53 is located between the collimating lens module 30 and the deflecting element 51. The positions of the deflecting element 51 and the diffraction element 53 can be interchanged with each other. After being collimated by the collimating lens module 30, the detection light L2 first deflects to the detection light L3 through the deflecting element 51, and then diffracts and divides into the detection light L4 through the diffraction element 53. Or the detection light L2 first diffracts and divides into the detection light L5 through the diffraction element 53 and then deflects to the detection light L6 through the deflecting element 51. Both modes can still achieve good technical results.

In this embodiment, the anti-reflective film 55 is an optical coating that covers the input surface 511 and output surface 513 of the deflecting element 51. The anti-reflective film 55 is used to reduce or eliminate reflected light on the surface of the deflecting element 51, thereby increasing the transmittance of the deflecting element 51 and achieving better application effects. In other embodiments, as shown in FIG. 5, the anti-reflective film 55 can also cover the input surface 531 and output surface 533 of the diffraction element 53. It should be noted that if the wavelength and intensity of the detection light L2 through the anti-reflective film 55 are different, the materials of the anti-reflective film 55 are also correspondingly different. For example, the materials of the anti-reflective film 55 can be selected such as magnesium fluoride, aluminum oxide, silicon dioxide, silicon monoxide, titanium dioxide, and zinc sulfide.

The light-emitting module 100a (100b, 100c) provided in the embodiment of the present disclosure, the number of light source arrays 11 in the light source module 10 increases, and multiple sets of detection light L1 emitted by different light source arrays 11 are collimated into detection light L2 by the collimating lens module 30, and diffracted and divided by the deflecting diffraction module 50, and then deflected to form a beam array of detection light L4 (or L6). The cross-sectional area of the beam array (i.e. the area of the detection light spot array P) is not greater than the cross-sectional area of a set of detection light L1 generated by any one light source array 11, resulting in more beams in the stacked beam array, thereby increasing the light spot distribution density of the detection light spot array P (where the cross-sectional area remains unchanged, and the light spots become more), parameters related to target objects within various distance ranges can be more accurately collected.

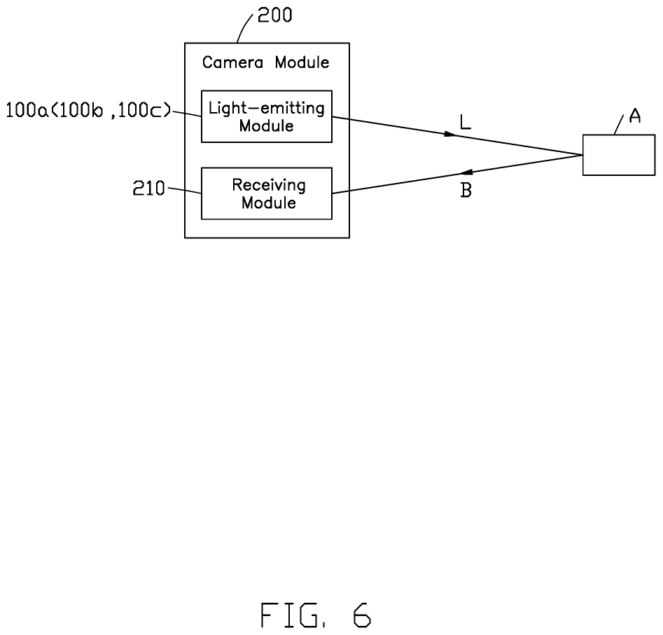

The present disclosure also provides a camera module. As shown in FIG. 6, the camera module 200 includes a light-emitting module 100a (100b, 100c) and a receiving module 210. The light emission module 100a (100b, 100c) is used to emit an array of detection light spots P that illuminates a target object A. The receiving module 210 is used to collect the reflected light B that is the detection light L reflected by the target object in real-time, and further obtain the three-dimensional position information, image information, and size information of the target object.

For the light-emitting module 100a (100b, 100c), since the lasers 11a of each light source array 11 are divided into at least two batches, and the at least two batches alternately emit light, and the receiving module 210 can clearly identify the position of the light spots on the target object.

In one embodiment, the receiving module 210 may include a filter (not shown), an optical lens (not shown), and a depth sensor (not shown). The filter and the optical lenses are used to collect the reflected light B, and only specific of light having wavelengths within the target range are allowed to pass through. That is, the remaining light used to obtain the image of target object A. The depth sensor and related electronic circuit is used to calculate the flight time of the detection light L from the light-emitting module 100a (100b, 100c) and the reflected light B to the receiving module 210, and to synthesize multiple frames of images of target object A at high speed into a single image, ultimately completing the collection of three-dimensional position information, image information, and size information of target object A. This can block interfering light signals, reduce various non correlated irregular signal noise.

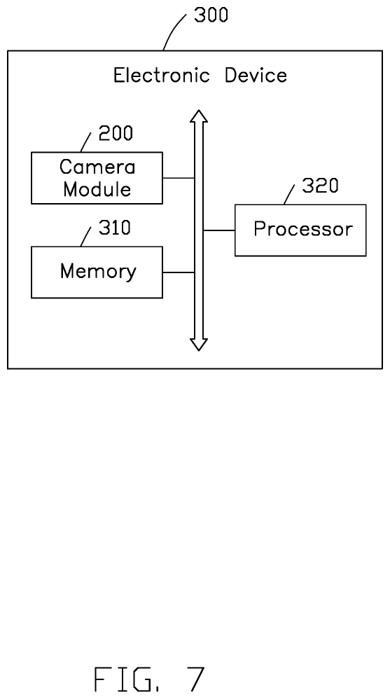

The present disclosure also provides an electronic device. As shown in FIG. 7, the electronic device 300 includes a camera module 200, a memory 310, and a processor 320. The camera module 300 is used for collecting information, the memory 310 is used for storing information, and the processor 320 is used to control the camera module 200 and the memory 310, while processing information exchanged between the electronic device 300 and the outside world during the interaction process.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A light-emitting module comprising:
a light source module comprising at least two light source arrays, each of the at least two light source arrays configured to emit beams of detection light;
a collimating lens module on an output side of the light source module and comprising a plurality of collimating lenses configured for collimating the beams of detection light; and
a deflecting diffraction module on a side of the collimating lens module facing away the light source module, the deflecting diffraction module configured to superimpose groups of the detection light after collimated by the collimating lens module, to be an array of detection light spots.

2. The light-emitting module of claim 1, wherein the at least two light source arrays are configured to emit the beams of the detection light having different wavelengths.

3. The light-emitting module of claim 1, wherein each of the plurality of collimating lenses corresponds to one of the at least two light source arrays and collimate the detection light from the one of the at least two light source arrays.

4. The light-emitting module of claim 1, wherein the deflecting diffraction module comprises a deflecting element, the deflecting element is configured to deflect the beams of the detection light in different directions after collimated by the collimating lens module.

5. The light-emitting module of claim 4, wherein the deflecting element comprises a deflecting prism corresponding to all of the at least two light source arrays, or the deflecting element comprises a plurality of wedges, and each of the plurality of wedges corresponds to one of the at least two light source arrays.

6. The light-emitting module of claim 4, wherein the deflecting diffraction module further comprises an anti-reflective film, the anti-reflective film covers a surface of the deflecting element.

7. The light-emitting module of claim 4, wherein the deflecting diffraction module further comprises a diffraction element, the diffraction element is a diffractive optical element corresponding to all of the at least two light source arrays, or the diffraction element comprises a plurality of diffraction plates, and each of the plurality of diffraction plates corresponds to one of the at least two light source arrays.

8. A camera module comprising:
a light-emitting module configured to emit an array of detection light spots towards a target object, the light-emitting module comprising:
a light source module comprising at least two light source arrays, each of the at least two light source arrays configured to emit beams of detection light;
a collimating lens module on an output side of the light source module and comprising a plurality of collimating lenses; and
a deflecting diffraction module on a side of the collimating lens module facing away the light source module, the deflecting diffraction module configured to superimpose groups of the detection light after collimated by the collimating lens module, to be an array of detection light spots; and
a receiving module configured for collecting the detection light reflected by the target object in real-time, and further for obtaining one or more of three-dimensional position information, image information, and size information of the target object.

9. The camera module of claim 8, wherein the at least two light source arrays are configured to emit the beams of the detection light having different wavelengths or a same wavelength.

10. The camera module of claim 8, wherein each of the plurality of collimating lenses corresponds to one of the at least two light source arrays and collimate the detection light from the one of the at least two light source arrays.

11. The camera module of claim 10, wherein the deflecting diffraction module comprises a deflecting element, the deflecting element is configured to deflect the beams of the detection light in different directions after collimated by the collimating lens module.

12. The camera module of claim 11, wherein the deflecting element comprises a deflecting prism corresponding to all of the at least two light source arrays; or the deflecting element comprises a plurality of wedges, and each of the plurality of wedges corresponds to one of the at least two light source arrays.

13. The camera module of claim 11, wherein the deflecting diffraction module further comprises an anti-reflective film, the anti-reflective film covers a surface of the deflecting element.

14. The camera module of claim 11, wherein the deflecting diffraction module further comprises a diffraction element, the diffraction element is a diffractive optical element corresponding to all of the at least two light source arrays, or the diffraction element comprises a plurality of diffraction plates, and each of the plurality of diffraction plates corresponds to one of the at least two light source arrays.

15. An electronic device comprising:
the camera module of claim 9 configured for collecting information;
a memory for storing information; and
a processor configured for controlling the camera module and the memory, and processing information exchanged between the electronic device and outside world during an interaction process.
